(19) United States
(12) Patent Application Publication
(10) Pub. No.: US 2009/0020716 A1
(43) Pub. Date: Jan. 22, 2009

(54) MOTOR DRIVEN VALVE AND COOLING/HEATING SYSTEM

(76) Inventors: HIDEKI HOKAZONO, Setagaya-ku (JP); TAKAO HARADA, Setagaya-ku (JP)

Correspondence Address: STETINA BRUNDA GARRED & BRUCKER, 75 ENTERPRISE, SUITE 250, ALISO VIEJO, CA, 92656, US

(21) Appl. No.: 12/145,781

(22) Filed: Jun. 25, 2008

(30) Foreign Application Priority Data
Jul. 3, 2007 (JP) 2007-174783

(51) Int. Cl. F16K 31/04

(52) U.S. Cl. 251/129.11

(57) ABSTRACT

To provide a motor-driven valve without requirement that a check valve is separately connected through piping in parallel and without a built-in check valve. A motor-driven valve 1 according to the present invention having a valve body 7 linearly moving by rotation of a rotor 15 of an electric motor and controlling a valve opening between the valve body 7 and a valve seat 6, and the motor-driven valve 1 is characterized in that: in a first valve opening range, the valve opening and flow rate of fluid have a predetermined correlation, and in a second valve opening range, flow rate more or equal to four time as much as controllable maximum flow rate in the first valve opening range can pass the valve 1. It is possible to use the motor-driven valve 1 for cooling/heating systems and to control flow rate of refrigerant in cooling in the first valve opening range and allow a large amount of the refrigerant to pass the valve in heating, so that only one electronic valve can satisfy performance of conventional valves.

### CROSS-REFERENCE TO RELATED APPLICATIONS

The present application claims priority to Japanese Patent Application No. 2007-174783 entitled MOTOR-DRIVEN VALVE AND COOLING/HEATING SYSTEM filed on Jul. 3, 2007.

### STATEMENT RE: FEDERALLY SPONSORED RESEARCH/DEVELOPMENT

Not Applicable.

### BACKGROUND

1. Field of the Invention

The present invention relates to a motor-driven valve that can be used as an electronic expansion valve with check valve function in cooling/heating systems and a cooling/heating system with the motor-driven valve.

2. Description of the Related Art

As a conventional cooling/heating system (heat pump cycle), a system shown in FIG. is used. The cooling/heating system 51 is composed of a compressor 52; a switching valve 53 for switching flow passages for refrigerant to switch cooling/heating operation; an outdoor heat exchanger 54; a distributor 55 and a thermal expansion valve 56 through which the refrigerant passes in heating; a check valve 57 through which the refrigerant passes in cooling; a thermal expansion valve 58 with a check valve through which the refrigerant passes in cooling/heating operations; and an indoor heat exchanger 59, and the refrigerant flows in a direction of solid-line arrows in cooling, and flows in a direction of broken-line arrows in heating.

In the cooling/heating system 51, in cooling operation, refrigerant gas compressed by the compressor 52 flows into the outdoor heat exchanger 54 via the switching valve 53 and is condensed through heat exchange with atmospheric air; the refrigerant flows into the thermal expansion valve 58 with a check valve via the check valve 57 to perform insulation expansion; and then the refrigerant evaporates in the indoor heat exchanger 59 through heat exchange with indoor air to cool the room.

On the other hand, in heating operation, refrigerant gas compressed by the compressor 52 flows into the indoor heat exchanger 59 via the switching valve 53 and is condensed through heat exchange with indoor air to warm the room; the refrigerant flows into the thermal expansion valve 56 via the thermal expansion valve 58 with a check valve so as to be reduced in pressure; and then the refrigerant evaporates in the outdoor heat exchanger 54 after passing the distributor 55 and returns to the compressor 52.

The thermal expansion valve 58 with a check valve used for the cooling/heating system 51 has a built-in check valve, and in an original flow (in cooling), the valve 58 controls flow rate by an expansion valve portion, and in a reverse flow (in heating), the refrigerant passes through the check valve portion. Here, the flow rate of the refrigerant in the check valve portion is remarkably high in comparison to that in the original flow, so that it is necessary to manage the same flow rate as in connected pipes with almost no pressure loss.

Meanwhile, in order to control flow rate of refrigerant or the like in refrigeration cycle systems, a conventional motor-driven valve 70 shown in FIG. 6 is used. The motor-driven valve 70 is composed of a valve main body 75 having a first flow passage 72 and a second flow passage 73 that communicate with a valve chamber 71; a valve body 77 that contacts with and is separated from a valve seat 76 of the valve main body 75; a cylindrical shield case 79; a stator coil 80 disposed outside of the sealed case 79; a rotor 84 that rotates in the sealed case 79 through magnetization by feeding current to the stator coil 80 so as to be movable in a valve opening/closing directions; a male screw pipe 81 and a valve shaft holder 82 that allow the valve body 77 to contact with and be separated from the valve seat 76 via a valve shaft 74 through screw-feeding action with the valve shaft holder 82 by the rotation of the rotor 84 and so on. The rotor 84 is composed of a permanent magnet 83 and the valve shaft holder 82 fixed to the permanent magnet 83 through a stop ring 86.

The motor-driven valve 70 with the above-mentioned construction allows the rotor 84 to rotate through magnetization by feeding current to the stator coil 80 and allows the valve shaft holder 82 to rotate also to open and close the valve. The rotating motion of the valve shaft holder 82 is converted to vertical motion of the valve shaft 74, and when the valve shaft 74 moves downward and the valve body 77 abuts the valve seat 76 the flow passages are closed, on the other hand, when the valve shaft 74 moves upward and the valve body 77 is separated from the valve seat 76 the flow passages are opened.

In the conventional cooling/heating system shown in FIG. 5, although a thermal expansion valve with a built-in check valve or a thermal expansion valve and a check that are connected through a pipe in parallel are used, the check valve portion is large in diameter in comparison to the diameter of an opening of the expansion valve to reduce pressure loss, so that the construction of the thermal expansion valve with a built-in check valve itself becomes intricate and the size of the valve becomes large, resulting in increased manufacturing cost of the valve. On the other hand, the construction in which a thermal expansion valve and a check valve are connected in parallel requires additional piping and boding works, resulting in increased area to mount the valves and increased cost. And, in order to improve save-energy efficiency, an electronic expansion valve is used in place of the thermal expansion valve, which causes almost the same problem as described above.

### SUMMARY OF THE INVENTION

The present invention has been made in consideration of the above problems in the conventional cooling/heating systems, and the object thereof is to provide a motor-driven valve that provides the same performance as the conventional valve without requirement that a check valve is separately connected through piping in parallel and without a built-in check valve, and a cooling/heating system with the motor-driven valve.

To achieve the above object, the present invention relates to a motor-driven valve having a valve body linearly moving by rotation of a rotor of an electric motor and controlling a valve opening between the valve body and a valve seat, and the motor-driven valve is characterized in that: in a first valve opening range, the valve opening and flow rate of fluid have a predetermined correlation, and in a second valve opening range, flow rate more than four time as much as a controllable maximum flow rate in the first valve opening range can pass the valve.

With the motor-driven valve according to the present invention, since flow rate of fluid can be controlled in the first valve opening range, and a large amount of fluid can be flown in the second valve opening range, it is possible, for instance, to use the motor-driven valve for cooling/heating systems and to control flow rate of a refrigerant in cooling in the first valve opening range and allow a large amount of the refrigerant to pass the valve in heating. With this, it is avoidable to separately connect a check valve in parallel to a pipe as well as a problem caused by using a valve with a built-in check valve, which increases cost and size due to intricate construction of the valve itself, can be eliminated, because only one valve can satisfy the performance of the conventional valve, resulting in decreased cost and size.

In the above motor-driven valve, driving pulses can be fed to a driving coil of the electric motor to control the valve opening, and ratio of an opening area of the valve seat when whole pulses are applied to the area when intermediate pulses are applied may be four or more.

Further, in the above motor-driven valve, it is possible that driving pulses are fed to a driving coil of the electric motor to control the valve opening; an opening area of the valve seat is three times or more than a theoretical opening area of the valve seat that is required to control flow rate of the fluid in the first valve opening range; the fluid flow rate in the first valve opening range is controlled with driving pulses of which width is in a range between more or equal to a quarter and less or equal to two-thirds of whole pulses; and the valve opening is controlled to be maximum with driving pulses when whole pulses are applied.

In addition, in the above motor-driven valve, at the maximum valve opening fluid may flow in an opposite direction to that of fluid flowing in the first valve opening range, which allows, as described above, the flow of the refrigerant in cooling/heating operation to be switched.

Still further, in the above motor-driven valve, ratio of the opening are of the valve seat of the motor-driven valve to a minimum inner cross-sectional area of pipes in a system with the motor-driven valve may be 0.2 or more. With this, pressure loss in a system with the motor-driven valve of the present invention may be suppressed low.

In the above motor-driven valve, a driving screw for converting the rotational motion of the rotor to the liner motion of the valve body can be mounted, and ratio of nominal diameter of the driving screw to a diameter of the valve seat opening may be 1.3 or less. Reducing nominal diameter of the driving screw makes it possible to reduce frictional force generated at a complete screw portion, which causes effect of increased load (product of deferential pressure between two flow passages of fluid across the valve seat and opening area of the valve seat) due to enlarged valve opening area of the valve seat in comparison to conventional valves to be suppressed small.

In the above motor-driven valve, a spring can be disposed between the valve body and the rotor, for urging the valve body to the valve seat side, and ratio of compression load to the spring in a fully-closed state of the valve to product of deferential pressure between two flow passages across the valve seat in the fully-closed state of the valve and the opening area of the valve seat may be a half or less. With this, it is possible to reduce friction loss at the driving screw portion and the like at the rotation of the rotor.

In the above motor-driven valve, ratio of a length of a complete screw portion of the driving screw to the nominal diameter of the driving screw may be 0.75 or more. Making the nominal diameter of the driving screw as small as possible allows, as described above, friction force generated at the complete screw portion to become small, which suppress the influence in load due to increased opening area of the valve seat small.

Further, it is possible to construct the motor-driven valve described above such that a tip portion of the valve body is formed to be a circular-truncated-cone shape with reduced diameter toward the tip side; fluid flow rate is controlled by a portion between a side face of the circular-truncated-cone portion and an inner circumferential face of the valve seat opening; an angle between the side face of the circular-truncated-cone portion and an axis of the valve body is 15 degree or less; and ratio of a length of the side face in a direction of the axis to moving amount of the valve body over whole pulse width is 0.7 or less.

In addition, in the motor-driven valve, the diameter of the valve seat opening may be more or equal to 3 mm.

Further, the present invention relates to a cooling/heating system, and the system is characterized to have a motor-driven valve having a valve body linearly moving by rotation of a rotor and controlling a valve opening between the valve body and a valve seat, and the motor-driven valve is characterized in that: in a first valve opening range, flow rate in cooling operation is controlled, and in a second valve opening range, in heating operation, refrigerant more than four time as much as a controllable maximum flow rate of refrigerant in the cooling operation can pass the valve. With the present invention, as described above, it is avoidable to separately connect a check valve in parallel to a pipe as well as a problem caused by using a valve with a built-in check valve, which is increased cost and size due to intricate construction of the valve itself, can be eliminated, because only one valve can satisfy the performance of the conventional valve, resulting in decreased cost and size.

As described above, with the present invention, it becomes unnecessary to separately connect a check valve to a pipe in parallel and to prepare a built-in check valve structure, and the performance of the conventional valve can be satisfied with a single valve with reduced cost and downsizing.

### BRIEF DESCRIPTION OF THE DRAWINGS

The present invention will be more apparent from the ensuring description with reference to the drawings, wherein:

Figure is a cross-sectional view of a motor-driven valve according to an embodiment of the present invention;

FIG. 2 is a graph showing flow rate performance of the motor-driven valve shown in FIG. 1;

FIGS. 3A and 3B cross-sectional views showing examples that the motor-driven valve shown in FIG. 1 is used in cooling/heating systems in cooling operation and in heating operation respectively;

FIG. 4 is a front view showing a valve body and its neighboring elements of the motor-driven valve shown in FIG. 1;

FIG. 5 is a flowchart showing a conventional cooling/heating system; and

FIG. 6 is a cross-sectional view of a conventional motor-driven valve.

### BEST MODE TO CARRY OUT THE INVENTION

Next, embodiments of the present invention will be explained with reference to drawings.

FIG. 1 shows a motor-driven valve according to an embodiment of the present invention. The motor-driven valve 1 roughly comprises: a valve main body 5 having a first flow passage 3 and a second flow passage 4 that communicate with a valve chamber 2; a valve body 7 that contacts with and is separated from a valve seat 6 of the valve main body 5; a cylindrical shield case 9; a stator coil (driving coil) 10 disposed outside of the sealed case 9; a rotor 15 that rotates in the sealed case 9 through magnetization by feeding current to the stator coil 10 so as to be movable in a valve opening/closing directions and is provided with a permanent magnet 14 fixed to a cylindrical valve shaft holder 12 through a stop ring 13 and the like; a male screw pipe 11 and the valve shaft holder 12 that allow the valve body 7 to contact with and be separated from the valve seat 6 through screw-feeding action by the rotation of the rotor 15 and so on. The rotor 15 is composed of the permanent magnet 14 and the valve shaft holder 12 fixed to the permanent magnet 14 through the stop ring 13. Further, the permanent magnet 14 (rotor 15) and a stator 20 compose a stepping motor.

The valve main body 5 is formed of metal such as brass and is provided with the valve chamber 2 therein, and with the valve chamber 2 communicates the first flow passage 3 and the second flow passage 4. The valve seat 6 is formed in a flow passage of the valve chamber 2 to the second flow passage 4 side. To the upper portion of the valve main body 5 is fixed through welding the shield case 9 through a flange plate 22. In addition, on the right side face of the valve main body 5 stands a stop ring 34 to fix the stator 20.

The valve body 7 is formed at the lower end portion of a valve shaft 24 made of brass. The valve body 7 is formed to be a circular-truncated-cone shape in which an upper portion thereof is a column with larger diameter and a lower portion and an intermediate portion downwardly reduce their diameter. The shape of the valve body 7 is one of the characteristics of the present invention, and this shape provides desired flow quantity characteristic.

In order to allow the valve body 7 to contact with and be separated from the valve seat 6, the male screw pipe 11, the valve shaft holder 12 and the like are used. In the cylindrically formed male screw pipe 11, a lower portion thereof is fixed to the valve main body 5 and the portion extends toward the rotor 15. On an intermediate outer surface of the male screw pipe 11 is threaded a male screw portion (driving screw) 25, which engages with a female screw portion 27 of the valve shaft holder 12.

The valve shaft holder 12 positions outside of the male screw pipe 11 and is formed to be a cylindrical shape opening downward. The female screw 27 is threaded on a lower inner face of the valve shaft holder 12. To an inner portion of the valve shaft holder 12 is fitted an upper portion with reduced diameter of the valve shaft 24, and those are connected by a push nut 28.

The valve shaft 24 is provided with the valve body 7 at the lower end portion thereof, and is inserted in the valve shaft holder 12 so as to vertically be movable, and is always urged downward by a compressive coil spring 29 that is mounted in the valve shaft holder 12 after shrunk.

The shield case 9 is made of metal without magnetism such as stainless steel so as to be a cylindrical shape with a ceiling, and is fixed through welding or the like to the flange plate 22 at an upper portion of the valve main body 5. Inside of the shield case 9 is maintained air-tightly.

The stator 20 is composed of a yoke 23 made of a magnetism material and a stator coil 10 wound on the yoke 23. The stator 20 is fitted outside of the shield case 9. The stator 20 is fixed to the valve main body 5 through the stop ring 34 by a locking member 20a mounted on the bottom face.

A return spring 30 is composed of a compressive coil spring and is mounted to the outer circumference of the push nut 28 that is fixed through press to the upper end of the valve shaft 24. The return spring 30 abuts the inner surface of the shield case 9 and urges it so as to return the engagement between the male screw portion 25 and the female screw portion 27 when the male screw portion 25 and the female screw portion 27 disengage with each other. The return spring 30 may be attached in a state that it is loosely fitted to and mounted on the outer circumference of the push nut 28 or resiliently be fitted to the outer circumference of the push nut 28.

The valve shaft holder 12 and the permanent magnet 14 are connected with each other through the stop ring 13, and the stop ring 13 a metal (brass) ring that is inserted at the formation of the permanent magnet 14. To the inner circumference of the stop ring 13 is fitted an upper projecting potion of the valve shaft holder 12, and the outer circumference of the projection portion is fixed through caulking to integrally connect the permanent magnet 14, the stop ring 13 and the valve shaft holder 12.

To the male screw pipe 11 is fixed a lower stopper body (fixed stopper) 33 that is a member composing a stopper mechanism. The lower stopper body 33 is formed of resin and is ring-shaped, and a plate-like lower stopper piece 33a projects upward. On the other hand, to the valve shaft holder 12 is fixed an upper stopper body (movable stopper) 32 that is another member composing the stopper mechanism, and the upper stopper body 32 is also made of resin and is ring-shaped, and a plate-like upper stopper piece 32a projects downward. The upper stopper piece 32a of the upper stopper body 32 and the lower stopper piece 33a of the lower stopper body 33 are constructed such that they can abut each other.

Next, the motion of the motor-driven valve 1 with the above construction will be explained.

Feeding current to the stator coil 10 in a direction for magnetization allows the rotor 15 including the permanent magnet 14 to rotate, which causes the valve shaft holder 12 to rotate in relation to the male screw pipe 11. Here, since the lower portion of the male screw pipe 11 is fixed to the valve main body 5, the screw-feeding mechanism by the male screw portion 25 of the male screw pipe 11 and the female screw portion 27 of the valve shaft holder 12 allows, for instance, the valve shaft holder 12 to move downward, which causes the valve body 7 to press the valve seat 6 to close the valve opening.

The moment that the valve opening is closed, the upper stopper body 32 does not abut the lower stopper body 33 yet, so that under the condition that the valve body 7 closes the valve opening, the valve shaft holder 12 further drops while rotating. With this, the compression coil spring 29 is compressed to absorb the force generated by the drop of the valve shaft holder 12. After that, when the rotor 15 further rotates to drop the valve shaft holder 12, the upper stopper piece 32a of the upper stopper body 32 abuts the lower stopper piece 33a of the lower stopper body 33 to forcibly stop the drop of the valve shaft holder 12 even through current feeding to the stator coil 10 continues.

Next, feeding current to the stator coil 10 in another direction for magnetization allows the rotor 15 to rotate in an inverse direction to the above-mentioned direction in relation to the male screw pipe 11 fixed to the valve main body 5, and due to the screw-feeding mechanism, the valve shaft holder 12 moves upward, and the valve body 7 at the lower end of the valve shaft 24 is separated form the valve seat 6 to open the valve opening. In the above motion, friction loss at the screw portion, or friction loss or torsion loss at the spring portion are generated.

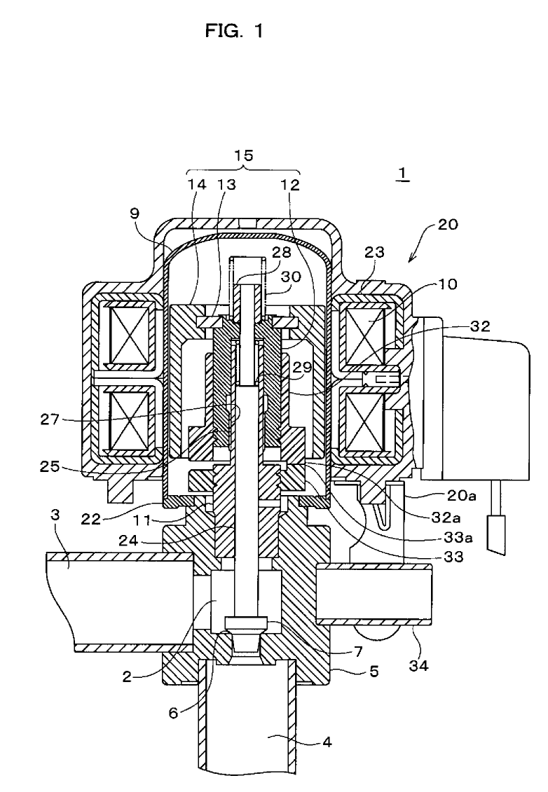

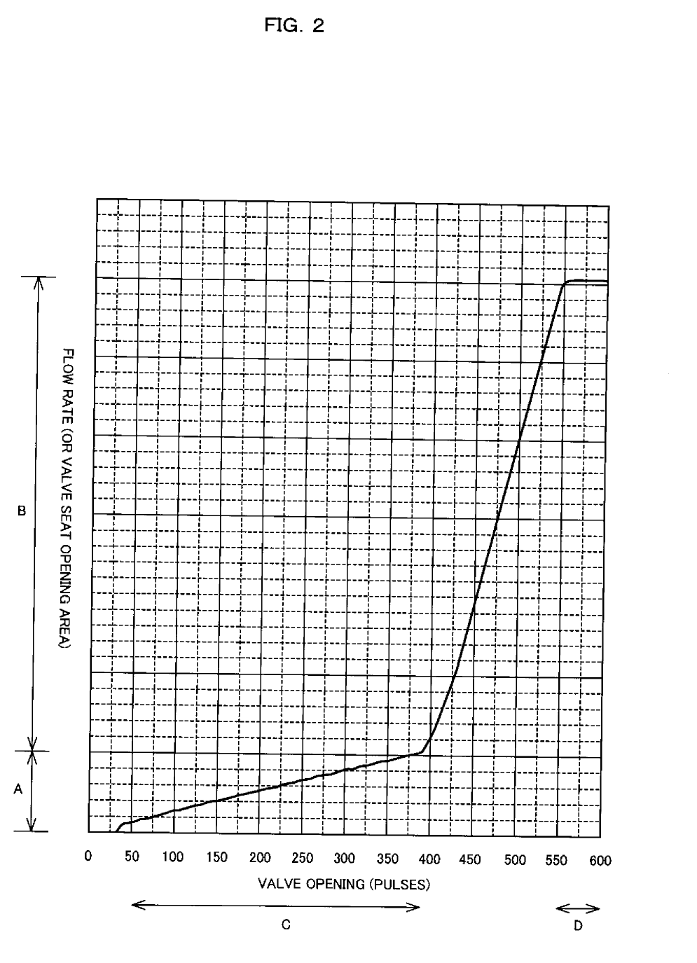

Next, flow rate performance of the motor-driven valve 1 will be explained mainly with reference to FIG. 2.

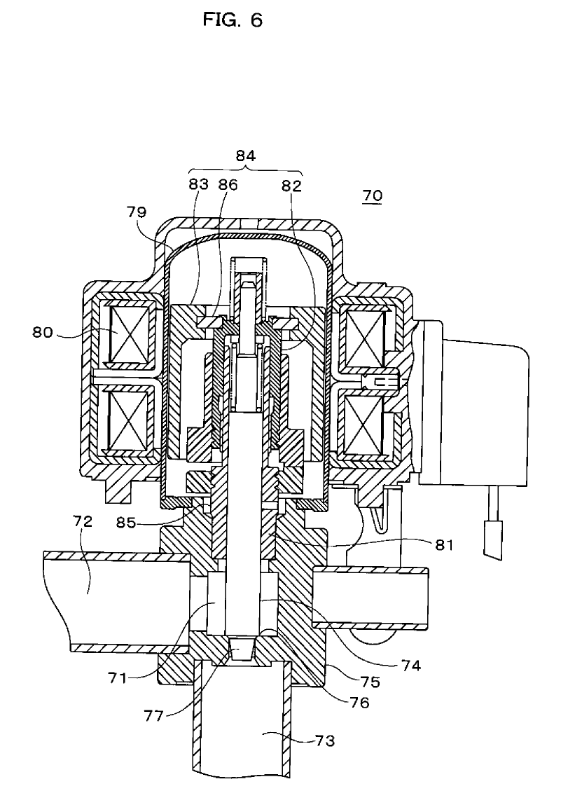

As stated above, the valve body 7 of the motor-driven valve 1 is characterized to have, in comparison to the valve body 77 of the motor-driven valve 70 shown in FIG. 6, lower height of the lower circular-truncated-cone portion thereof and larger diameter in a whole, with this, the opening area of the valve seat 6 is also larger than that of the valve seat 76 of the motor-driven valve 70.

With the above construction, 0 to 600 driving pulses are applied to the stator coil 10 of the stepping motor to control the valve opening, in the range of the valve opening (approximately 50 to 400 pulses), which is indicated by “C” in FIG. 2, flow rate of fluid changes almost in proportion to the valve opening. Next, between approximately 400 to 550 pulses, the flow rate of fluid changes almost in proportion to the valve opening with larger inclination than that in the first valve opening range, and between approximately 550 to 600 pulses, which is indicated by “D” in FIG. 2, the flow rate of fluid becomes constant. With this, in the second valve opening range D flow rate B becomes approximately six times as much as controllable maximum flow rate A in the first valve opening range C.

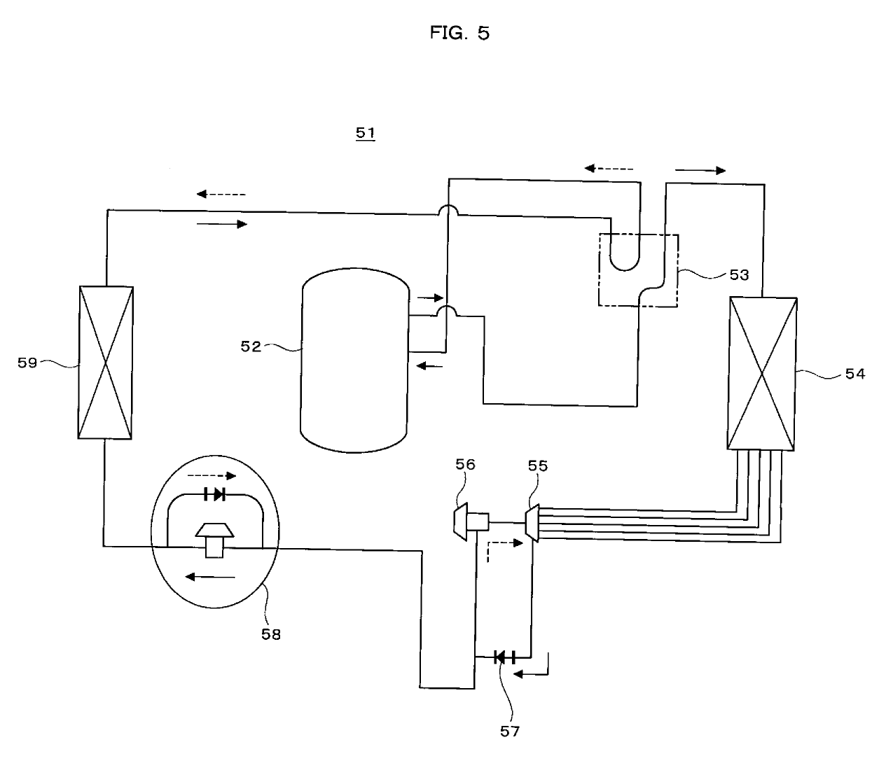

Next, as an embodiment that the motor-driven valve 1 is used, a case that the motor-driven valve 1 is used in place of the thermal expansion valve 58 with a check valve in the cooling/heating system 51 shown in FIG. 5 will be explained mainly with reference to FIGS. 1 to 3.

As explained in “background art” column, in the cooling/heating system 51 shown in FIG. 5, in cooling operation, refrigerant flows into the thermal expansion valve 58 with a check valve via the check valve 57 to perform insulation expansion, and then the refrigerant flows into the indoor heat exchanger 59. On the other hand, in heating operation, the refrigerant flows into the thermal expansion valve 58 with a check valve from the indoor heat exchanger 59, and the refrigerant is reduced in pressure, and then the refrigerant flows into the distributor 55. Here, it is necessary to control flow rate with the expansion valve portion of the thermal expansion valve 58 with a check valve in cooling, and to allow a large amount of refrigerant to flow in heating.

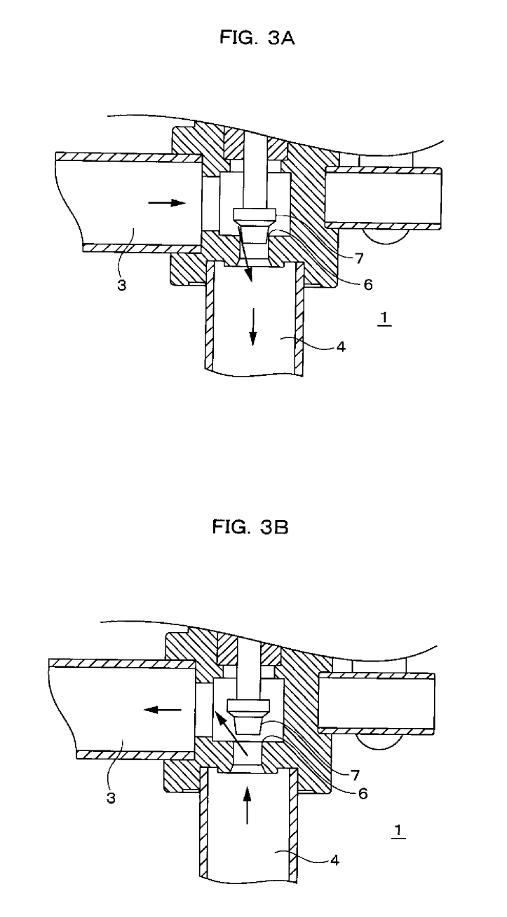

Then, in the flow illustrated in FIG. 5, in place of the thermal expansion valve 58 with a check valve, the motor-driven valve 1 is mounted to allow refrigerant to flow from the first flow passage 3 to the second flow passage 4 in cooling as shown in FIG. 3(a) as well as utilizing a minute clearance between the valve seat 6 and the lower portion of the valve body 7, the motor-driven valve 1 controls the flow rate in the valve opening range C in FIG. 2. With this, it becomes possible to control flow rate of the refrigerant in cooling in the range between 50 to 400 pulses.

On the other hand, in heating operation, as shown in FIG. 3(b), the refrigerant is to be flown from the second flow passage 4 to the first flow passage 3, and the lower portion of the valve body 7 is caused to be separated far from the valve seat 6 to allow the refrigerant to pass in the second valve opening range D in FIG. 2. With this, a large amount of refrigerant can flow in heating in the range between 550 and 600 pulses.

In addition, in the above embodiment, although it is constructed that in the second valve opening range D in FIG. 2, the flow rate B that is approximately six times as much as the controllable maximum flow rate A in the first valve opening range C, the ration of the flow rate A to the flow rate B is appropriately changeable, and setting the ratio more or equal to four can constitute a motor-driven valve preferably used in cooling/heating systems.

Here, in constituting the motor-driven valve described above, the ration of the valve opening area (the opening area between the valve seat 6 and the valve body 7) of the valve seat 6 when whole pulses (600 pulses) are applied to the valve opening area of the valve seat 6 when intermediate pulses (approximately 300 pulses) are applied can be four or more. In addition, the motor-driven valve can be constituted to have a valve opening area (opening area at an orifice portion) more or equal to three times as much as a theoretical valve opening area (opening area at an orifice portion) that is required to control flow rate of fluid in the first valve opening range C in FIG. 2.

Further, in case that the motor-driven valve 1 is used for the cooling/heating system 51, it is preferable that even through a large amount of refrigerant passes the motor-driven valve 1, almost no pressure loss is generated. So, the ratio of the opening area (opening area of the orifice portion) of the valve seat of the motor-driven valve 1 to the minimum inner diameter of pipes used for the cooling/heating system 51 is preferably be 0.2 or more.

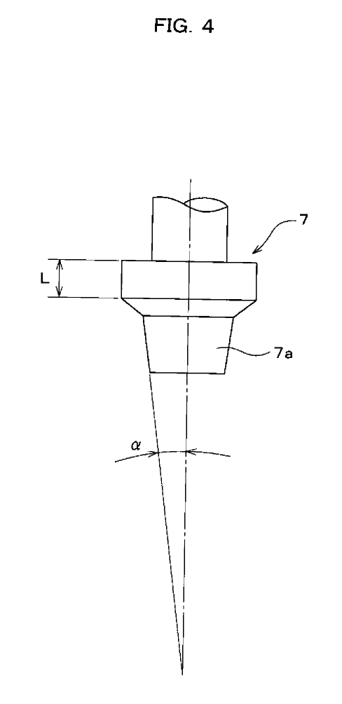

In addition, the motor-driven valve 1 is provided with a larger opening area of the valve seat 6 in comparison to conventional valves, so that load that is calculated as a product of deferential pressure between two flow passages 3 and 4 across the valve seat 6 and the opening area of the valve seat 6 becomes large. Therefore, in order to suppress the influence of the load low, the male screw portion 25 is formed to be have a small diameter, for instance, the ratio of nominal diameter of the male screw portion 25 to the opening are of the valve seat 6 is preferably 1.3 or less. In addition, in order to reduce friction loss generated between the rotor 15 and the compression coil spring 29 in the valve-opening motion of the rotor 15, the ratio of compression load to the compression coil spring 29 in the open state of the valve to the product of deferential pressure between the two flow passages 3, 4 across the valve seat 6 in the fully-closed state of the valve and the opening area of the valve seat 6 is preferably a half or less. In order to maintain facial pressure to the screw portion appropriate and to satisfy the above control performance against the increased load, the ratio of the length of a complete screw portion of the male screw portion 25 to the nominal diameter of the male screw portion 25 is preferably 0.75 or more. Further, as shown in FIG. 4, it is preferable that an angle αbetween the side face 7a of the lower circular-truncated-cone portion of the valve body 7 and the axis of the valve body 7 is 15 degree or less, and the ratio of the length of the side face 7a in a direction of the axis to moving amount of the valve body 7 over whole pulse width is 0.7 or less. In addition, the diameter of the opening of the valve seat 6 is preferably 3 mm or more.

Meanwhile, in the above embodiment, although the explanation was made in case that the motor-driven valve 1 is used in place of the thermal expansion valve 58 with a check valve of the cooling/heating system 51 shown in FIG. 5, the valve 1 may be used in place of the thermal expansion valve 56 or the check valve 57. Further, besides the cooling/heating system 51, the motor-driven valve 1 is applicable to other systems utilizing the flow rate performance as shown in FIG. 2.

1. A motor-driven valve having a valve body linearly moving by rotation of a rotor of an electric motor and controlling a valve opening between the valve body and a valve seat, said motor-driven valve characterized in that: in a first valve opening range, said valve opening and a flow rate of fluid have a predetermined correlation, and in a second valve opening range, a flow rate more than four times as much as a controllable maximum flow rate in the first valve opening range can pass through the valve.

2. The motor-driven valve as claimed in claim 1, wherein driving pulses are fed to a driving coil of the electric motor to control the valve opening, and the ratio of an opening area of the valve seat when whole pulses are applied to the area when intermediate pulses are applied is four or more.

3. The motor-driven valve as claimed in claim 1, wherein driving pulses are fed to a driving coil of the electric motor to control the valve opening; an opening area of the valve seat is three times or more than a theoretical opening range of the valve seat that is required to control flow rate of the fluid in the first valve opening area; the fluid flow rate in the first valve opening range is controlled with driving pulses of which width is in a range between more or equal to a quarter and less or equal to two-thirds of whole pulses; and the valve opening is controlled to be maximum with driving pulses when whole pulses are applied.

4. The motor-driven valve as claimed in claim 3, wherein at the maximum valve opening fluid flows in an opposite direction to that of fluid flowing in the first valve opening range.

5. The motor-driven valve as claimed in claim 2, wherein the ratio of the opening are of the valve seat of the motor-driven valve to a minimum inner cross-sectional area of pipes in a system with the motor-driven valve is 0.2 or more.

6. The motor-driven valve as claimed in one of claims claim 1, wherein further comprising a driving screw for converting the rotational motion of the rotor to the linear motion of the valve body, the ratio of a nominal diameter of the driving screw to a diameter of the valve seat opening being 1.3 or less.

7. The motor-driven valve as claimed in claim 1, wherein a spring is disposed between the valve body and the rotor, for urging the valve body to the valve seat side, and the ratio of compression load to the spring in a fully-closed state of the valve to the product of differential pressure between two flow passages across the valve seat in the fully-closed state of the valve and the opening area of the valve seat is a half or less.

8. The motor-driven valve as claimed claim 6, wherein the ratio of a length of a complete screw portion of the driving screw to the nominal diameter of the driving screw is 0.75 or more.

9. The motor-driven valve as claimed in claim 1, wherein a tip portion of the valve body is formed to be a circular-truncated-cone shape with reduced diameter toward the tip side; fluid flow rate is controlled by a portion between a side face of the circular-truncated-cone portion and an inner circumferential face of the valve seat opening; an angle between the side face of the circular-truncated-cone portion and an axis of the valve body is 15 degree or less; and the ratio of a length of the side face in a direction of the axis to moving amount of the valve body over whole pulse width is 0.7 or less.

10. The motor-driven valve as claimed in claim 1, wherein the diameter of said valve seat opening is more or equal to 3 mm.

11. A cooling/heating system with a motor-driven valve having a valve body linearly moving by rotation of a rotor and controlling a valve opening between the valve body and a valve seat, said motor-driven valve characterized in that: in a first valve opening range, a flow rate in cooling operation is controlled, and in a second valve opening range, in heating operation, refrigerant more than four times as much as a controllable maximum flow rate of refrigerant in the cooling operation can pass through the valve.

12. The motor-driven valve as claimed in claim 3, wherein the ratio of the opening are of the valve seat of the motor-driven valve to a minimum inner cross-sectional area of pipes in a system with the motor-driven valve is 0.2 or more.

13. The motor-driven valve as claimed in claim 4, wherein the ratio of the opening are of the valve seat of the motor-driven valve to a minimum inner cross-sectional area of pipes in a system with the motor-driven valve is 0.2 or more.

14. The motor-driven valve as claimed in claim 2, further comprising a driving screw for converting the rotational motion of the rotor to the linear motion of the valve body, the ratio of a nominal diameter of the driving screw to a diameter of the valve seat opening being 1.3 or less.

15. The motor-driven valve as claimed in claim 3, further comprising a driving screw for converting the rotational motion of the rotor to the linear motion of the valve body, the ratio of a nominal diameter of the driving screw to a diameter of the valve seat opening being 1.3 or less.

16. The motor-driven valve as claimed in claim 4, further comprising a driving screw for converting the rotational motion of the rotor to the linear motion of the valve body, the ratio of a nominal diameter of the driving screw to a diameter of the valve seat opening being 1.3 or less.

17. The motor-driven valve as claimed in claim 5, further comprising a driving screw for converting the rotational motion of the rotor to the linear motion of the valve body, the ratio of a nominal diameter of the driving screw to a diameter of the valve seat opening being 1.3 or less.

18. The motor-driven valve as claimed in claim 6, wherein a spring is disposed between the valve body and the rotor, for urging the valve body to the valve seat side, and the ratio of compression load to the spring in a fully-closed state of the valve to the product of differential pressure between two flow passages across the valve seat in the fully-closed state of the valve and the opening area of the valve seat is a half or less.

19. The motor-driven valve as claimed in claim 18, wherein the ratio of a length of a complete screw portion of the driving screw to the nominal diameter of the driving screw is 0.75 or more.
